(19) United States
(12) Patent Application Publication
(10) Pub. No.: US 2024/0166209 A1
(43) Pub. Date: May 23, 2024

(54) SYSTEM AND METHOD FOR CONTROLLING A CRUISE CONTROL SYSTEM OF A VEHICLE USING THE MOODS OF ONE OR MORE OCCUPANTS

(71) Applicant: Toyota Motor Engineering & Manufacturing North America, Inc., Plano, TX (US)

(72) Inventors: Rohit Gupta, Santa Clara, CA (US); Ziran Wang, San Jose, CA (US); Kyungtae Han, Palo Alto, CA (US); Hazem Abdelkawy, Woluwe Saint Pierre (BE); Paul Li, Daly City, CA (US); Satoshi Nagashima, Long Island, NY (US); Pujitha Gunaratne, Northville, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/992,026

(22) Filed: Nov. 22, 2022

(51) Int. Cl. B60W 30/16

(52) U.S. Cl. CPC B60W 30/16; B60W 2540/049; B60W 2540/21; B60W 2540/22; B60W 2554/4041; B60W 2556/10; B60W 2556/35; B60W 2556/45; B60W 2720/10; B60W 2754/30

(57) ABSTRACT

Systems and methods for controlling a cruise control system of a vehicle using the moods of one or more occupants are described herein. In one example, a system includes a processor and a memory in communication with the processor. The memory includes instructions that, when executed by the processor, cause the processor to determine, using a mood model, the mood of at least one occupant of a vehicle and a setting for a cruise control to maintain a distance between the vehicle and a preceding vehicle based on the determined mood. The instructions then cause the processor to set the cruise control to operate according to the setting.

### TECHNICAL FIELD

The subject matter described herein relates, in general, to systems and methods for determining a setting for a cruise control system. Specifically, the disclosed technologies are directed to determining a setting for a cruise control system based on the moods of one or more occupants of a vehicle.

### BACKGROUND

The background description provided is to present the context of the disclosure generally. Work of the inventor, to the extent it may be described in this background section, and aspects of the description that may not otherwise qualify as prior art at the time of filing are neither expressly nor impliedly admitted as prior art against the present technology.

Some current vehicles have cruise control systems that can automatically control a speed of a vehicle based on an operator selection. Advantages of cruise control can include, for example, one or more of a reduction in the degree of fatigue of the operator of the vehicle, an assurance that the speed of the vehicle is less than a regulatory speed limit, an increase in fuel efficiency of the vehicle, or the like.

More recently, technologies for cruise control have been developed so that a cruise control system can control a braking system of the vehicle, in conjunction with control of the position of the throttle, to maintain a distance between the vehicle and a preceding vehicle. Such a cruise control system is sometimes referred to as adaptive cruise control (ACC). Typically, the distance between the vehicle and the preceding vehicle may be a preset condition or may be manually adjustable by the operator of the vehicle.

### SUMMARY

This section generally summarizes the disclosure and is not a comprehensive explanation of its full scope or all its features.

In one embodiment, a system includes a processor and a memory in communication with the processor. The memory includes instructions that, when executed by the processor, cause the processor to determine, using a mood model, the mood of at least one occupant of a vehicle and a setting for a cruise control to maintain a distance between the vehicle and a preceding vehicle based on the determined mood. The instructions then cause the processor to set the cruise control to operate according to the setting.

In another embodiment, a method includes the steps of determining, using a mood model, a mood of at least one occupant of a vehicle, determining, using the mood of the at least one occupant, a setting for a cruise control to maintain a distance between the vehicle and a preceding vehicle, and causing the cruise control to operate according to the setting.

In yet another embodiment, a non-transitory computer-readable medium includes instructions that, when executed by a processor, cause the processor to determine, using a mood model, a mood of at least one occupant of a vehicle, determine, using the mood of the at least one occupant, a setting for a cruise control to maintain a distance between the vehicle and a preceding vehicle, and cause the cruise control to operate according to the setting.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example of a vehicle incorporating a personalized automatic cruise control (P-ACC) system that can adjust the distance between the vehicle and a preceding vehicle using the moods of one or more occupants of the vehicle.

FIG. 2 illustrates a view of the cabin, including the occupants, of a vehicle incorporating the P-ACC system.

FIG. 3 illustrates one example of a vehicle incorporating the P-ACC system.

FIG. 4 illustrates a more detailed view of the P-ACC system.

FIG. 5 illustrates a process flow of the P-ACC system of FIG. 4.

FIG. 6 illustrates a detailed view of a remote server that may be part of or utilized with the P-ACC system of FIG. 4.

FIG. 7 illustrates a process flow of a P-ACC system that utilizes a recommender engine to determine the appropriate setting for the P-ACC system using the moods of multiple occupants.

FIG. 8 illustrates a method for determining the appropriate setting of a P-ACC system using the moods of one or more occupants of a vehicle that incorporates the P-ACC system.

### DETAILED DESCRIPTION

Described are systems and methods for controlling a P-ACC system using the moods of one or more occupants of the vehicle incorporating the P-ACC system. In one example, the system and method utilize a mood model that can determine the mood of one or more vehicle occupants using sensor information. The sensor information may be related to the facial, speech, and body arousal of the one or more vehicle occupants. Using the determined moods of the occupants, the system and method can determine the appropriate following distance for having the vehicle follow a preceding vehicle. The setting can then cause the vehicle to file the preceding vehicle at the appropriate following distance.

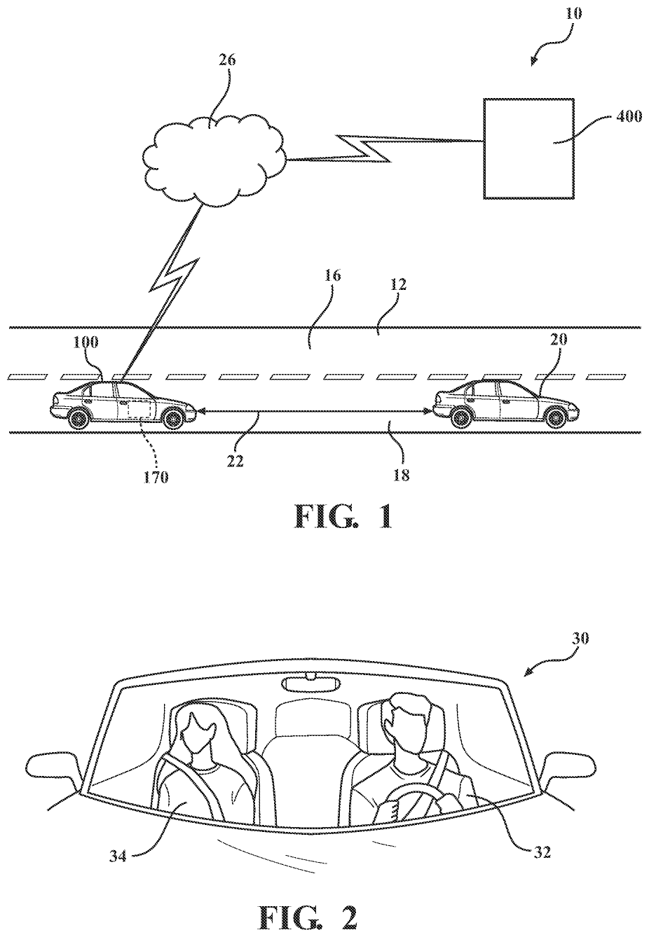

Referring to FIG. 1, illustrated is an example 10 of a vehicle 100 that incorporates a P-ACC system 170. In the example 10, the vehicle 100 is traveling on a road 12, which includes lanes 16 and 18. In this particular example, the vehicle 100 is traveling in the lane 18 and is following a preceding vehicle 20 that is also traveling in the lane 18. As such, a following distance 22 is defined as the distance between the vehicle 100 and the preceding vehicle 20 that the vehicle 100 is following. It should be understood that the example 10 detailing the configuration of the road 12 is merely an example. The configuration of the road 12 can vary considerably from application to application. In some cases, the road 12 may have a single lane or may have numerous multiple lanes. Furthermore, the road 12 may be a traditional road that is accessible by all vehicles and pedestrians or could be a limited access road, such as a highway or expressway that requires exit/entrance ramps to access the limited access road.

As will be explained in greater detail later in this disclosure, the P-ACC system 170 can determine the appropriate following distance 22 for following a preceding vehicle, such as the preceding vehicle 20, by utilizing one or more moods of the occupants of the vehicle. The P-ACC system 170 may also utilize external devices, such as a remote server 400 that it can access via a network 26, which may be a distributed network. As will be explained later, the remote server 400 may provide services to the P-ACC system 170, such as the ability to train a mood model that determines the mood of the occupants and/or allow access to a recommender engine in situations where the moods of multiple occupants are being considered.

As mentioned above, the P-ACC system 170 can adjust the following distance by determining an appropriate setting based on the moods of one or more occupants of the vehicle. The occupants of the vehicle can include the operator of the vehicle, sometimes referred to as a driver, and the passengers of the vehicle. For example, FIG. 2 illustrates a front view 30 of the vehicle 100, which illustrates that the vehicle 100 includes an operator occupant 32 and a passenger occupant 34.

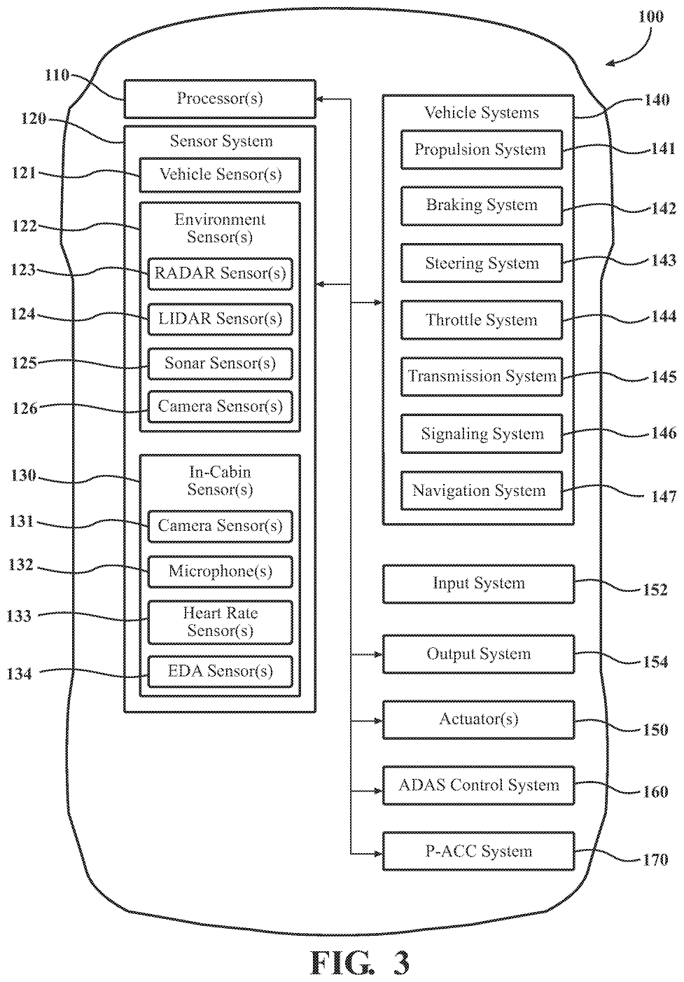

Referring to FIG. 3, an example of the vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, includes one or more automated or autonomous systems, and thus benefits from the functionality discussed herein.

In various embodiments, the automated/autonomous systems or combination of systems may vary. For example, in one aspect, the automated system is a system that provides autonomous control of the vehicle according to one or more levels of automation, such as the levels defined by the Society of Automotive Engineers (SAE) (e.g., levels 0-5). As such, the autonomous system may provide semi-autonomous or fully autonomous control, as discussed in relation to an advanced driver assistant system (ADAS) control system 160.

The vehicle 100 also includes various elements. It will be understood that in various embodiments it may not be necessary for the vehicle 100 to have all of the elements shown in FIG. 3. The vehicle 100 can have any combination of the various elements shown in FIG. 3. Further, the vehicle 100 can have additional elements to those shown in FIG. 3. In some arrangements, the vehicle 100 may be implemented without one or more of the elements shown in FIG. 3. While the various elements are shown as being located within the vehicle 100 in FIG. 3, it will be understood that one or more of these elements can be located external to the vehicle 100. Further, the elements shown may be physically separated by large distances and provided as remote services (e.g., cloud-computing services).

Some of the possible elements of the vehicle 100 are shown in FIG. 3 and will be described along with subsequent figures. However, a description of many of the elements in FIG. 3 will be provided after the discussion of FIGS. 3-8 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

In either case, the vehicle 100 includes the P-ACC system 170. The P-ACC system 170 may be incorporated within the ADAS control system 160 or may be separate, as shown. As explained earlier, the P-ACC system 170 may utilize the moods of one or more occupants of the vehicle 100 to determine the appropriate following distance 22 for the vehicle 100 to utilize when following a preceding vehicle, such as the preceding vehicle 20 of FIG. 1.

With reference to FIG. 2, one embodiment of the P-ACC system 170 is further illustrated. As shown, the P-ACC system 170 includes one or more processor(s) 210. Accordingly, the processor(s) 210 may be a part of the P-ACC system 170, or the P-ACC system 170 may access the processor(s) 210 through a data bus or another communication path. Additionally, it should be understood the processor(s) 210 may be one or more processors mounted within the vehicle 100 that may be utilized by other systems and subsystems, such as the processor(s) 110 of FIG. 3. In one or more embodiments, the processor(s) 210 is an application-specific integrated circuit that is configured to implement functions associated with instructions that may be stored as a P-ACC module 222. In general, the processor(s) 210 is an electronic processor such as a microprocessor capable of performing various functions described herein.

In one embodiment, the P-ACC system 170 includes a memory 220 that stores the P-ACC module 222. The memory 220 may be a random-access memory (RAM), read-only memory (ROM), a hard disk drive, a flash memory, or other suitable memory for storing the P-ACC module 222. The P-ACC module 222 is, for example, computer-readable instructions that, when executed by the processor(s) 210, cause the processor(s) 210 to perform the various functions disclosed herein.

Furthermore, in one embodiment, the P-ACC system 170 includes one or more data store(s) 230. The data store(s) 230 is, in one embodiment, an electronic data structure such as a database that is stored in the memory 220 or another memory and that is configured with routines that can be executed by the processor(s) 210 for analyzing stored data, providing stored data, organizing stored data, and so on. Thus, in one embodiment, the data store(s) 230 stores data used by the P-ACC module 222 in executing various functions.

In one embodiment, the data store(s) 230 includes sensor data 232, along with, for example, other information used by the P-ACC system 170. The sensor data 232 may include sensor data collected by the sensor system 120 of the vehicle 100. As best shown in FIG. 3, the sensor system can include vehicle-specific vehicle sensor(s) 120, environment sensor(s) 122, and in-cabin sensor(s) 130.

In one or more arrangements, the vehicle-specific vehicle sensor(s) 120 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle-specific vehicle sensor(s) 120 can be configured to detect, and/or sense one or more characteristics of the vehicle 100. In one or more arrangements, the vehicle-specific vehicle sensor(s) 120 can include a speedometer to determine a current speed of the vehicle 100.

The environment sensor(s) 122 may be configured to acquire, and/or sense driving environment data. “Driving environment data” includes data or information about the external environment in which an autonomous vehicle is located or one or more portions thereof. For example, the one or more environment sensor(s) 122 can be configured to detect, quantify and/or sense obstacles in at least a portion of the external environment of the vehicle 100 and/or information/data about such obstacles. Such obstacles may be stationary and/or dynamic objects, such as preceding vehicles. As an example, in one or more arrangements, the sensor system 120 can include one or more radar sensor(s) 123, one or more LIDAR sensor(s) 124, one or more sonar sensor(s) 125, and/or one or more camera(s) 126. In one or more arrangements, the one or more camera(s) 126 can be high dynamic range (HDR) or infrared (IR) cameras.

The in-cabin sensor(s) 130 may be configured to capture information related to activities within the cabin of the vehicle 100. As explained previously, the moods of one or more occupants of the vehicle 100 are utilized to determine the following distance for following a preceding vehicle. The in-cabin sensor(s) 130 may provide information that can be utilized to determine the moods of the occupants of the vehicle 100.

As such, the in-cabin sensor(s) 130 may include one or more camera sensor(s) 131 that can capture the movement and/or facial expressions of the occupants of the vehicle. One or more microphone(s) 132 may be utilized to collect audio information, such as voice-related information generated by the occupants. The in-cabin sensor(s) 130 can include biometric sensors, such as heart rate sensor(s) 133 and electrodermal activity (EDA) sensor(s) 134. The heart rate sensor(s) 133 may be configured to output information related to the pulse of the one or more occupants.

The electrodermal activity (EDA) sensor(s) 134 can be utilized to collect information that may be related to the stress that an occupant is experiencing. Moreover, the EDA sensor(s) may work by detecting the changes in electrical (ionic) activity resulting from changes in sweat gland activity of the one or more occupants. Signals generated by the EDA sensor(s) 134 may reflect the intensity of the emotional state of one or more occupants of the vehicle. This reflection of intensity is sometimes referred to as emotional arousal. The level of emotional arousal changes in response to the environment. As such, if something is scary, threatening, joyful, or otherwise emotionally relevant, the subsequent emotional change also increases eccrine sweat gland activity causing signals generated by the EDA sensor(s) 134 to change.

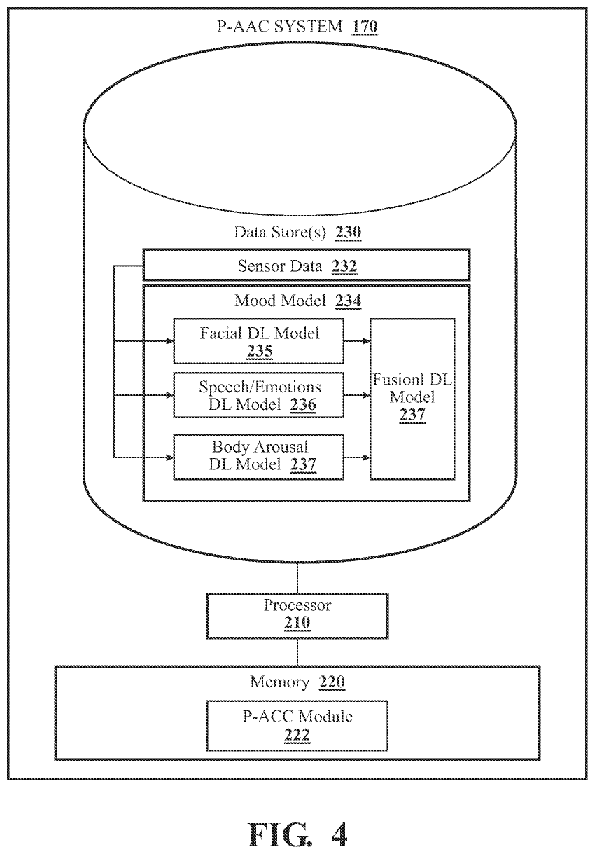

Returning attention to FIG. 4, the data store(s) 230 may also include the mood model 234. The mood model 234 may be a trained model to recognize certain types of patterns. Moreover, the sensor data 232 may be provided to the mood model 234 in the mood model 234 can then determine the mood of one or more occupants of the vehicle 100. The mood model 234 may be trained using inverse reinforcement learning (IRL) methodologies. IRL considers the problem of extracting a reward function from the observed (nearly) optimal behavior of an expert acting in an environment.

The mood model 234 may be a single model or may be multiple models working in concert. In this example, the mood model 234 includes four different deep learning (DL) models including a facial DL model 235, a speech/emotions DL model 236, a body arousal DL model 237 and a fusion DL model 238. The facial DL model 235 considers information from the camera sensor(s) to extract the facial expressions of the one or more occupants. The facial expressions extracted by the facial DL model 235 can then be used to predict the emotional state of the occupants, such as if the occupants are happy, sad, scared, etc. The speech/emotions DL model 236 considers information from the microphone(s) 132 to extract speech/emotions of the occupants. In like manner, the speech/emotions DL model 236 can provide some information regarding the emotional state of the occupants.

Finally, the body arousal DL model 237 utilizes biometric information, such as information from the heart rate sensor(s) 133 and the EDA sensor(s) 134, to determine the arousal of the one or more occupants, such as if the occupant perceives the environment as being scary, threatening, joyful, etc. The outputs of the facial DL model 235, the speech/emotions DL model 236, and/or the body arousal DL model 237 are provided to the fusion DL model 238, which fuses the outputs that are used to determine the overall mood of each occupant. The moods of each of the occupants can then be utilized to determine the appropriate following distance for the vehicle 100 to follow preceding vehicles.

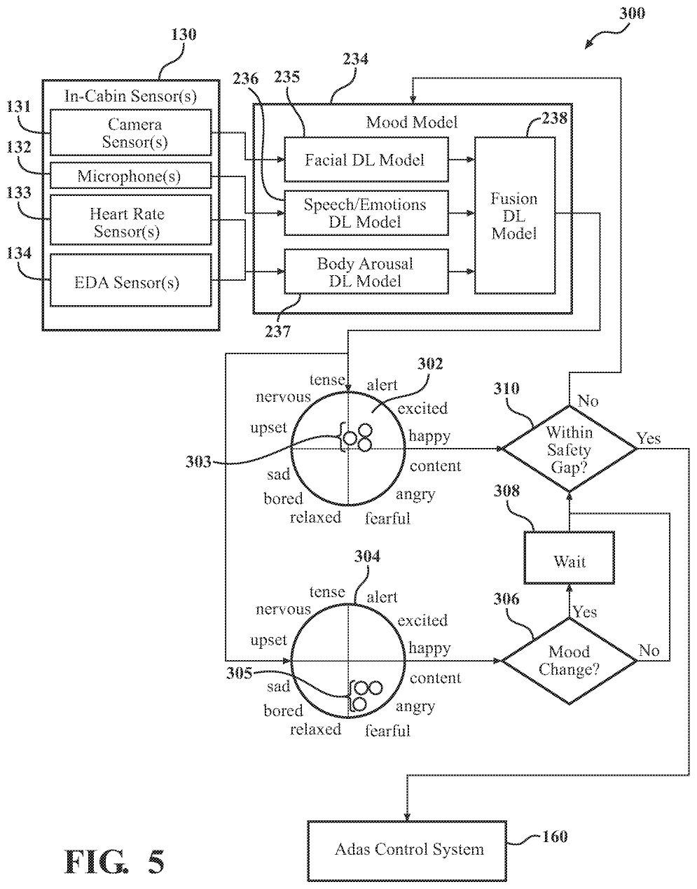

As mentioned before, the P-ACC module 222 includes instructions that generally cause the processor(s) 210 to determine the mood of an occupant (or moods of multiple occupants) and use that mood to set the following distance of the vehicle 100. FIG. 5 illustrates a process flow 300 that may occur when the processor(s) 210 executes the instructions stored within the P-ACC module 222. The process flow 300 of FIG. 5 will describe utilizing a mood of a single occupant, such as the driver, to determine the following distance that should be utilized by the vehicle 100 when following a preceding vehicle. Using moods of multiple occupants will be described later in this description.

The process flow 300 begins by having the in-cabin sensor(s) 130 collect information regarding the occupant of the vehicle 100. As mentioned before, the in-cabin sensor(s) 130 can include camera sensor(s) 131, microphone(s) 132, heart rate sensor(s) 133, and EDA sensor(s) 134. Additionally, the in-cabin sensor(s) 130 could also include other sensors not specifically mentioned in the preceding sentence and elsewhere in this description.

The mood model 234 receives information generated by the in-cabin sensor(s) 130 to determine the overall mood of the occupant. As mentioned before, the facial DL model 235 may receive information from the camera sensor(s) 131 that may include images of the face of the occupant, the speech/emotions DL model 236 may receive audio information from the microphone(s) 132 of audio generated by the occupant or otherwise present within the cabin of the vehicle 100, and the body arousal DL model 237 may receive information from the heart rate sensor(s) 133 and/or the EDA sensor(s) 134.

The outputs of the facial DL model 235, the speech/emotions DL model 236, and the body arousal DL model 237 are provided to a fusion DL model 238, which can output the mood of the occupant. In this example, the output of the mood model 234 is shown graphically as a circle 302. The circle 302 includes a top half that represents the emotions upset, nervous, tense, alert, excited, and happy. The bottom half of the circle 302 represents the emotions sad, bored, relaxed, fearful, angry, and content. Generally, the emotions at the top half of the circle 302 indicate that the occupant is engaged and aware of the environment surrounding the vehicle 100. In contrast, the emotions at the bottom half of the circle 302 indicate that the occupant may be disinterested of the environment surrounding the vehicle 100.

In this example, the mood of the occupant indicated by the circle 302 is represented by outputs 303, which generally indicates that the occupant is aware of their environment (the outputs 303 are in the top half of the circle 302) and may vary between tense and alert. Based on the outputs 303, the P-ACC module 222 may cause the processor(s) 210 to determine the following distance and/or an appropriate setting for the ADAS control system 160, resulting in the vehicle 100 following a preceding vehicle at the determined following distance.

The mood of the occupant can be utilized to determine the following distance using historical information. For example, the P-ACC system 170 can collect information when the occupant is operating the vehicle without the cruise control activated. The P-ACC system 170 can generally determine the following distance of the vehicle 100 with respect to a preceding vehicle and make a note of the mood of the driver. Over time, following distances can be associated with different moods of the driver. For example, the P-ACC system 170 may determine that the driver utilizes one following distance when they are happy and another following distance when they are mad. Once the mood is determined by the mood model 234, the P-ACC system 170 may then use historical mood/following distance information collected to determine the appropriate following distance based on the mood.

The chart below illustrates different P-ACC settings for the P-ACC system 170 based on different moods. It should be understood that the P-ACC settings mentioned below are merely examples and may vary from application to application. The safety override is a system that monitors the distance between the vehicle 100 and the surrounding vehicles. If the safety distances are compromised, the safety settings may override any settings determined by the P-ACC system 170.

| Mood | P-ACC Setting | Basis |
|---|---|---|
| Relaxed | Comfort | Historical Driving |
| Sad | Custom (individual | Historical Driving |
| | preference) | |
| Angry | Slow down and increase the | Safety Override Active |
| | gap between vehicles | |
| Happy | Custom (individual | Historical Driving |
| | preference) | |
| Nervous | Slow down and increase the | Safety Override Active |
| | gap between vehicles | |

As such, historical driving information may be utilized when the occupant is relaxed, sad, and/or happy, while a safety override may be utilized when the driver is angry and/or nervous.

This following distance may be compared to a safety gap in element 310 to determine if the determined following distance is a safe distance to have the vehicle 100 utilize as the following distance. Moreover, if the following distance is too short and would place the vehicle 100 and/or occupants of the vehicle 100 to close the preceding vehicle, which may result in an accident, the process flow 300 may return to the beginning or utilize a factory or other previously determined setting. Otherwise, if the following distance is within the safety gap, the P-ACC module 222 may cause the processor(s) 210 to instruct the ADAS control system 160 to set the cruise control such that vehicle 100 is controlled to operate based on the following distance setting.

More specifically, the ADAS control system 160, upon receiving the setting, may control the vehicle systems 140 shown in FIG. 3, such that the vehicle 100 files a preceding vehicle at the determined following distance. The vehicle systems 140 can vary from application to application. Therefore, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. In the example shown in FIG. 3, vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The process flow 300 can also perform numerous determinations regarding the mood of the occupant. For example, the process flow 300 shows not only outputs 303 but also outputs 305 represented within the circle 304. If the outputs 305 in the outputs 303 were substantially similar in indicating the same mood, the process flow may proceed to element 310, as indicated by element 306.

In this example, the outputs 305 indicate that the mood of the occupant is less aware of the environment and is more fearful and/or angry and is different from the mood indicated by the outputs 303. In this situation where subsequent outputs 305 differ from prior outputs 303, the process flow 300 may wait, as indicated by element 308, for a period of time, such as 10 seconds, to confirm that the mood change of the occupant is correct and has not changed yet again before proceeding to element 310.

As mentioned in FIG. 1, the P-ACC system 170 may be able to access services provided by the remote server 400. For example, services provided by the remote server 400 can include training and/or otherwise modifying or developing the mood model 234. The mood model 234 generated by the remote server 400 can then be provided via the network 26 to the P-ACC system 170 for use by the P-ACC system 170.

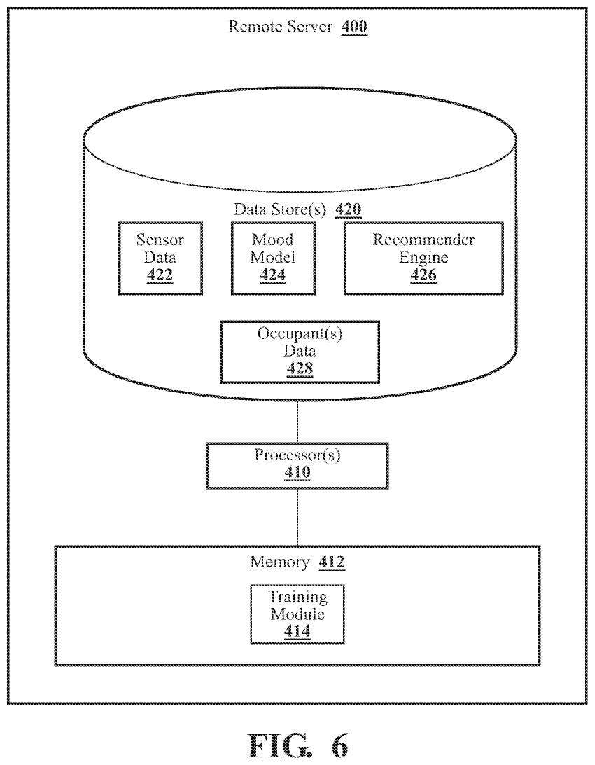

In addition, the remote server 400 may also be able to recommend a setting for the cruise control for a following distance when the moods of multiple occupants are being considered. Moreover, FIG. 6 illustrates one example of the remote server 400. Also, it should be understood that any of the services provided by the remote server 400 could also be performed by the P-ACC system 170.

In this example, the remote server 400 includes a processor(s) 410 that may be a single processor or multiple processors working in concert. The processor(s) 410 may be located within the remote server 400 and may be accessed remotely by the remote server 400. The processor may be similar to the processor(s) 210, and any description regarding the processor(s) 210 is equally applicable to the processor(s) 410.

A memory 412, which may be similar to the memory 220 of FIG. 4, may be in communication with the processor(s) 410 and may include a training module 414 or other modules that include instructions for executing any of the functions of the remote server 400. In this example, the training module 414 may be utilized to train a mood model 424 and/or a recommender engine 426, which will be described in detail later in this disclosure.

The remote server 400 may also include one or more data store(s) 420 that can store information that is utilized by the processor(s) 410 and/or generated by the processor(s) 410 when executing any of the instructions located within the memory 412. Information stored by the data store(s) 420 can include sensor data 422, one or more mood models 424, one or more recommender engines 426, and occupant data 428. The sensor data 422 may be sensor data collected by the vehicle 100 or other vehicles that the occupant or occupants have utilized. The occupant data 428 may include information relating to how the occupant operates the vehicle when in a particular mood. For example, when not utilizing cruise control, the occupant may operate or prefer their vehicle to operate in a way that differs from others when in a particular mood. For example, some occupants, while happy and engaged with the environment, may follow the preceding vehicle closer than other occupants having the same mood.

The mood model 424 may be similar to the mood model 234 of FIG. 4 and may be trained utilizing the sensor data 422 and/or the occupant data 428. As mentioned before, the mood model 424 and/or the mood model 234 may be trained using an IRL-type methodology.

The recommender engine 426 may be a neural network, such as a deep learning neural network, that functions to receive moods from different occupants of the vehicle and then generate a following distance or appropriate setting to execute the following distance that would most likely satisfy, as best as possible, the multiple occupants of the vehicle. Moreover, the process flow 300 described in FIG. 5 focused on a single occupant, such as the driver. However, the systems and methods described herein can also utilize the moods of multiple occupants to determine a following distance or appropriate setting that is most likely to satisfy, as best possible, the multiple occupants of the vehicle by utilizing the recommender engine 426.

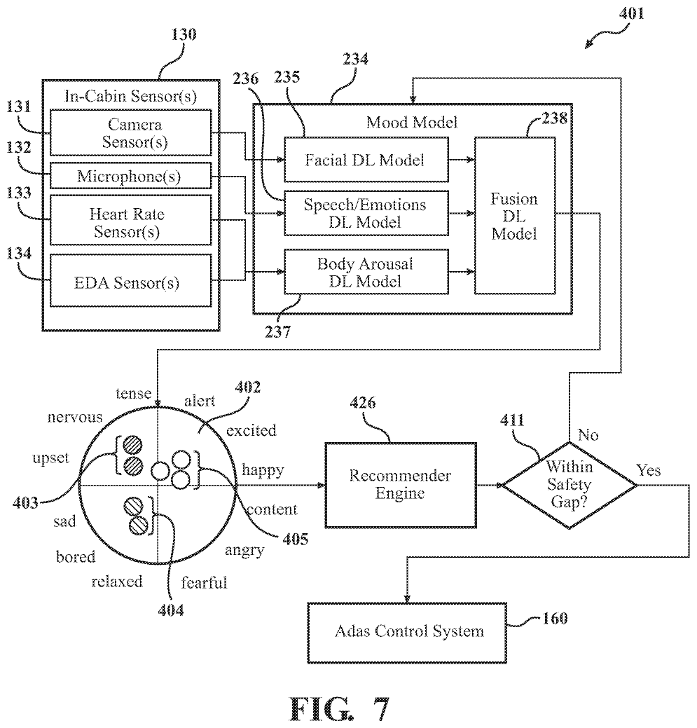

FIG. 7 illustrates a process flow 400 that utilizes the recommender engine 426. The process flow 400 has several similarities to the process flow 300. Therefore, any description regarding the process flow 300 that is otherwise not disclaimed when describing the process flow 400 is equally applicable to the process flow 400. Like before, the process flow 400 utilizes the mood model 234 to generate a mood. However, in this example, the mood model 234 generates moods for each of the occupants of the vehicle based on information collected from the in-cabin sensor(s) 130.

In this example, three occupants are located within the vehicle 100, and outputs 403-405 have been generated for each of the occupants and are represented within the circle 402. The outputs 403-405, which represent the moods of the different occupants, are provided to the recommender engine 426, which can predict an appropriate following distance or setting that would cause the vehicle 100 to utilize the following distance. The recommendation by the recommender engine 426 may be based on historical data based on the following mood of the occupants in different driving conditions, such as traffic, weather, road condition, time of day, week, month, type of trip, type of car, availability of entertainment/gaming, etc.

The recommender engine 426 may suggest mood profiles by analyzing occupants' current trip scores (fuel consumption score, acceleration score, braking score, and driving score) and mood data (driver→happy, occupant-1→sad, occupant-2→serene, etc.) of the various occupants in the vehicle 100. The recommender engine 426 may also consider if the occupant is alone or with their spouse, family, friends, parents/in-laws, and/or colleagues. The mood profile may automatically prompt the driver to suggest the most suitable gap profile by calculating the highest similarity trip score among other drives. Moreover, the recommender engine 426 may adopt nearest neighbor, singular value decomposition, and deep neural network model accordingly.

The following distance may be determined to a safety gap, such as shown by element 411. If the following distance is within the safety gap, the process flow 401 provides the setting or appropriate following distance to the ADAS control system 160, which will cause the vehicle 100 to follow a preceding vehicle using the determined following distance.

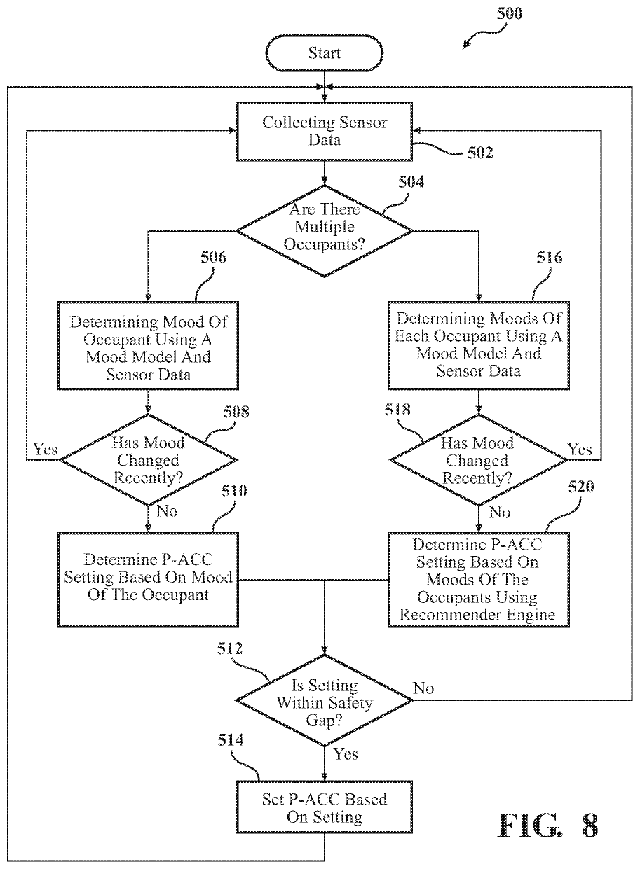

Referring to FIG. 8, a method 500 for controlling a vehicle having a P-ACC system is shown. The method 500 will be described from the viewpoint of the vehicle 100 of FIG. 3 and the P-ACC system 170 of FIG. 4. However, it should be understood that this is just one example of implementing the method 500. While method 500 is discussed in combination with the P-ACC system 170, it should be appreciated that the method 500 is not limited to being implemented within the P-ACC system 170, but is instead one example of a system that may implement the method 500.

The method 500 beings at step 502, wherein the P-ACC module 222 causes the processor(s) 210 to collect information from the sensor system 120. In one example, information collected from the sensor system may include information from the in-cabin sensor(s) 130, including visual, audible, and/or biometric information regarding any of the occupants located within the vehicle 100.

In step 504, the P-ACC module 222 causes the processor(s) 210 to determine if multiple occupants are located within the vehicle 100. If there is only a single occupant within the vehicle 100, such as the driver, the method 500 proceeds to step 506, wherein the P-ACC module 222 causes the processor(s) 210 to determine the mood of the occupant utilizing the mood model 234 and sensor data 232. As explained previously, the mood model 234 may be a single model or may be multiple models working in concert. In this example, the mood model 234 includes four different deep learning (DL) models including a facial DL model 235, a speech/emotions DL model 236, a body arousal DL model 237 and a fusion DL model 238.

In step 508, the P-ACC module 222 causes the processor(s) 210 to determine if a previously determined mood has recently changed. If the mood has recently changed, the method 500 may return to step 502. Otherwise, the method 500 will proceed to step 510, where a cruise control setting will be determined based on the mood of the occupant. Moreover, the cruise control setting represents the following distance between the vehicle 100 and a preceding vehicle when the cruise control is activated. As mentioned previously, the setting and/or following distance may be based on historical information.

In step 512, the P-ACC module 222 causes the processor(s) 210 to determine if the setting would result in the following distance that would be outside a safety gap. If the setting would result in the following distance that is outside the safety gap, the method 500 may either and/or return to step 502, where it begins again. Otherwise, the P-ACC module 222 causes the processor(s) 210 set the cruise control of the vehicle 100 by controlling one or more vehicle systems 140 using the setting previously determined in step 510.

Returning to step 504, if it is determined that there are multiple occupants, the method 500 will proceed to step 516. In step 516, the P-ACC module 222 causes the processor(s) 210 to determine the moods of each of the occupants of the vehicle 100. As mentioned before, the mood model 234 may utilize sensor data 232 to determine the moods of each of the occupants of the vehicle 100.

In step 518, the P-ACC module 222 causes the processor(s) 210 to determine if the moods of the occupants have been changing. If the moods of the occupants have been changing, the method may return to step 502. Otherwise, the method 500 may proceed to step 520, which then utilizes the recommender engine 426, which may be located on a remote server 400, to determine the setting and/or appropriate distance for following a preceding vehicle when the cruise control of the vehicle 100 is activated.

In step 512, as mentioned before, the P-ACC module 222 causes the processor(s) 210 to determine if the setting would result in the following distance that would be outside a safety gap. If the setting would result in the following distance that is outside the safety gap, the method 500 may either and/or return to step 502, where it begins again. Otherwise, the P-ACC module 222 causes the processor(s) 210 set the cruise control of the vehicle 100 by controlling one or more vehicle systems 140 using the setting previously determined in step 520 as shown in step 514.

The vehicle 100 of FIG. 3 will now be discussed in full detail as an example environment within which the system and methods disclosed herein may operate. In one or more embodiments, the vehicle 100 may be a non-autonomous, semi-autonomous, or autonomous vehicle and may have the option of switching between these modes. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route.

The vehicle 100 can include one or more processor(s) 110. In one or more arrangements, the processor(s) 110 can be a main processor of the vehicle 100. For instance, the processor(s) 110 can be an electronic control unit (ECU). As noted above, the vehicle 100 can include the sensor system 120. The sensor system 120 can include one or more sensors. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 can include any suitable type of sensor. Various examples of different types of sensors will be described herein. However, it will be understood that the embodiments are not limited to the particular sensors described.

The vehicle 100 can include an input system 152. An “input system” includes any device, component, system, element or arrangement or groups thereof that enable information/data to be entered into a machine. The input system 152 can receive an input from a vehicle occupant. The vehicle 100 can include an output system 154. An “output system” includes any device, component, arrangement or groups thereof that enable information/data to be presented to a vehicle occupant.

The processor(s) 110, the ADAS control system 160, and/or the P-ACC system 170 can be operatively connected to communicate with the various vehicle systems 140 and/or individual components thereof. The processor(s) 110, the ADAS control system 160, and/or the P-ACC system 170 may be operable to control the navigation and/or maneuvering of the vehicle 100 by controlling one or more of the vehicle systems 140 and/or components thereof. For instance, when operating in an autonomous mode, processor(s) 110, the ADAS control system 160, and/or the P-ACC system 170 can control the direction and/or speed of the vehicle 100. The processor(s) 110, the ADAS control system 160, and/or the P-ACC system 170 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, direct, command, instruct, and/or enable an event or action to occur or at least be in a state where such event or action may occur, either directly or indirectly.

The vehicle 100 can include one or more actuators 150. The actuators 150 can be any element or combination of elements operable to modify, adjust and/or alter one or more of the vehicle systems 140 or components thereof to respond to receiving signals or other inputs from the processor(s) 110, the ADAS control system 160, and/or the P-ACC system 170. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and, when loaded in a processing system, can carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory in communication with the processor, the memory having instructions that, when executed by the processor, causes the processor to:
determine, using a mood model, a mood of at least one occupant of a vehicle,
determine, using the mood of the at least one occupant, a setting for a cruise control to maintain a distance between the vehicle and a preceding vehicle, and
cause the cruise control to operate according to the setting.

2. The system of claim 1, wherein the memory further comprises instructions that, when executed by the processor, causes the processor to:
receive sensor information that monitors one or more characteristics of the at least one occupant; and
wherein the mood model uses the sensor information to determine the mood of the occupant.

3. The system of claim 1, wherein the at least one occupant includes a plurality of occupants and the memory further comprises instructions that, when executed by the processor, causes the processor to:
determine, using the mood model, an individual mood for each of the plurality of occupants; and
determine, using a recommender engine that considers the individual moods for each of the plurality of occupants, the setting for the cruise control to maintain the distance between the vehicle and the preceding vehicle.

4. The system of claim 3, wherein the memory further comprises instructions that, when executed by the processor, causes the processor to:
collect historical information for the plurality of occupants, the historical information including historical moods of the plurality of occupants in different driving conditions; and
determine, by the recommender engine that considers the individual mood for each of the plurality of occupants and the historical information, the setting for the cruise control to maintain the distance between the vehicle and the preceding vehicle.

5. The system of claim 4, wherein the historical information further comprises historical information of different occupants that share similarities to the plurality of occupants.

6. The system of claim 1, wherein the mood model further comprises:
a facial expression deep learning model configured to predict a facial expression of the at least one occupant;
a speech emotion deep learning model configured to predict a speech emotion of the at least one occupant;
a body arousal deep learning model configured to predict a body arousal of the at least one occupant; and
a fusion deep learning model configured to predict the mood of the of the at least one occupant based on the facial expression, speech emotion, and body arousal of the at least one occupant.

7. The system of claim 1, wherein the memory further comprises instructions that, when executed by the processor, causes the processor to:
in response to determining, by the processor, that the distance between the vehicle and the preceding vehicle to maintain based on the setting is within a safety limit, cause the cruise control to operate according to the setting.

8. The system of claim 1, wherein the memory further comprises instructions that, when executed by the processor, causes the processor to:
determining at a first time, using the mood model, an updated mood of the at least one occupant of the vehicle;
determine at a second time that occurs after the first time, using the mood model, if the mood model outputs the updated mood; and
in response to the mood model outputting the updated mood at the second time, determine, using the updated mood of the at least one occupant, the setting for the cruise control to maintain an updated distance between the vehicle and the preceding vehicle.

9. A method comprising the steps of:
determining, by a processor using a mood model, a mood of at least one occupant of a vehicle;
determining, by the processor using the mood of the at least one occupant, a setting for a cruise control to maintain a distance between the vehicle and a preceding vehicle; and
causing, by the processor, the cruise control to operate according to the setting.

10. The method of claim 9, further comprising the steps of:
receiving, by the processor, sensor information that monitors one or more characteristics of the at least one occupant; and
wherein the mood model uses the sensor information to determine the mood of the occupant.

11. The method of claim 9, wherein the at least one occupant includes a plurality of occupants and further comprising the steps of:
determining, by the processor using the mood model, an individual mood for each of the plurality of occupants; and
determining, by a recommender engine that considers the individual moods for each of the plurality of occupants, the setting for the cruise control to maintain the distance between the vehicle and the preceding vehicle.

12. The method of claim 11, further comprising the steps of:
collecting historical information for the plurality of occupants, the historical information including historical moods of the plurality of occupants in different driving conditions; and
determining, by the recommender engine that considers the individual mood for each of the plurality of occupants and the historical information, the setting for the cruise control to maintain the distance between the vehicle and the preceding vehicle.

13. The method of claim 12, wherein the historical information further comprises historical information of different occupants that share similarities to the plurality of occupants.

14. The method of claim 9, further comprising the step of training the mood model on a remote server using inverse reinforcement learning.

15. The method of claim 9, wherein the mood model further comprises:
a facial expression deep learning model configured to predict a facial expression of the at least one occupant;
a speech emotion deep learning model configured to predict a speech emotion of the at least one occupant;
a body arousal deep learning model configured to predict a body arousal of the at least one occupant; and
a fusion deep learning model configured to predict the mood of the of the at least one occupant based on the facial expression, speech emotion, and body arousal of the at least one occupant.

16. The method of claim 9, further comprising the step of: in response to determining, by the processor, that the distance between the vehicle and the preceding vehicle to maintain based on the setting is within a safety limit, causing, by the processor, the cruise control to operate according to the setting.

17. The method of claim 9, further comprising the step of:
determining at a first time, by the processor using the mood model, an updated mood of the at least one occupant of the vehicle;
determining at a second time that occurs after the first time, by the processor using the mood model, if the mood model outputs the updated mood; and
in response to the mood model outputting the updated mood at the second time, determining, by the processor using the updated mood of the at least one occupant, the setting for the cruise control to maintain an updated distance between the vehicle and the preceding vehicle.

18. A non-transitory computer-readable medium having instructions that, when executed by a processor, cause the processor to:
determine, using a mood model, a mood of at least one occupant of a vehicle;
determine, using the mood of the at least one occupant, a setting for a cruise control to maintain a distance between the vehicle and a preceding vehicle; and
cause the cruise control to operate according to the setting.

19. The non-transitory computer-readable medium of claim 18, wherein the at least one occupant includes a plurality of occupants and the non-transitory computer-readable further having instructions that, when executed by the processor, cause the processor to:
determine, using the mood model, an individual mood for each of the plurality of occupants; and
determine, using a recommender engine that considers the individual moods for each of the plurality of occupants, the setting for the cruise control to maintain the distance between the vehicle and the preceding vehicle.

20. The non-transitory computer-readable medium of claim 19, wherein the non-transitory computer-readable further includes instructions that, when executed by the processor, cause the processor to:
collect historical information for the plurality of occupants, the historical information including historical moods of the plurality of occupants in different driving conditions; and
determine, by the recommender engine that considers the individual mood for each of the plurality of occupants and the historical information, the setting for the cruise control to maintain the distance between the vehicle and the preceding vehicle.
